(19) United States
(12) Patent Application Publication
(10) Pub. No.: US 2005/0261997 A1
(43) Pub. Date: Nov. 24, 2005

(54) DETERMINATION OF RISK FACTORS FOR USE IN A CARD REPLACEMENT PROCESS

(75) Inventors: Kenneth William Austin, Phoenix, AZ (US); Thomas G. Callaghan, High PT., NC (US); Ravinder Dhamija, Rohtak/Haryana (IN); Deborah L. Dierker, Phoenix, AZ (US); Beth Gallagher, Phoenix, AZ (US); Jeffrey William Gass, Phoenix, AZ (US); Tod J. Johnston, Phoenix, AZ (US); Marcel Leyva, Chandler, AZ (US); Sedettra Nicole Rankin, Phoenix, AZ (US); Guruprasad M. Shenoy, Phoenix, AZ (US); Mzilikazi Whitfield, Kernersville, NC (US)

Correspondence Address: FITZPATRICK CELLA HARPER & SCINTO, 30 ROCKEFELLER PLAZA, NEW YORK, NY, 10112, US

(73) Assignee: AMERICAN EXPRESS TRAVEL RELATED SERVICES COMPANY INC., New York, NY (US)

(21) Appl. No.: 10/709,697

(22) Filed: May 24, 2004

(51) Int. Cl. G06F 17/60

(52) U.S. Cl. 705/35; 705/30

(57) ABSTRACT

Processing requests for financial-related transactions. Upon receiving a communication from a caller, wherein the communication includes a request for a particular financial card, information is obtained from the customer for use in processing the request. A first set of criteria related to the information is evaluated to determine if the request involves potential fraud. Based upon the evaluation of the first set of criteria, a second set of criteria related to the information is selectively evaluated to determine if the request involves potential fraud. An indication of the evaluation is output and used to determine whether to issue the requested financial card.

### FIELD OF INVENTION

The present invention generally relates to limiting fraud, and more particularly, to an apparatus and method for performing an analysis of risk factors and use of the results of that analysis in order to perform an action related to a financial transaction account, such as, for example, replacement of a credit card or other type of financial card.

### BACKGROUND OF INVENTION

Minimizing attempted fraud in transactions involving telephonic or other oral communications is typically important to many entities, particularly when the fraud involves financial transactions. For example, when a person loses a credit card and contacts a credit card company via telephone to obtain a replacement, the credit card company often desires to ensure that the person calling is the true cardholder. If a person attempts to fraudulently obtain a replacement card of a different cardholder, then the person may use the replacement credit card to make fraudulent charges. The credit card company can often incur significant losses due to these fraudulent charges, so the credit card company typically desires to reduce or eliminate these type of fraudulent transactions.

In that regard, credit card companies often implement certain procedures and install technologies in an attempt to verify the identity of customers who call them. One such technology is the use of an Automatic Number Identification (ANI) service, which attempts to identify the telephone number of an incoming call. A credit card company can maintain a database of area codes from which it has historically received a high number of fraudulent callers. If the telephone number of the person calling is within one of those high fraud area codes, the credit card company can flag the call for additional procedures or investigation to attempt to verify the true identity of the caller.

However, the ANI service has certain limitations. For example, the ANI service does not easily permit a company to pinpoint the exact geographic location of the caller. Also, it is possible that multiple persons can be associated with the same telephone number, which can make it difficult to identify which of those persons is the caller. Ultimately, the ANI service only provides a general indication of whether the customer is from an area known to be associated with a high number of fraudulent transactions. However, if the customer is not calling from one of those high fraud area codes, the ANI service provides no indication to provide additional screening, although the customer may actually be attempting to actually engage in fraud.

Aside from credit card companies, many other entities receive calls from customers and desire a way to verify the true identity of the callers. This verification can be useful, for example, in determining whether to execute a particular transaction requested by a caller. Accordingly, a need exists for a more reliable way to minimize fraud in telephonic transactions or other transactions involving oral communications, or to screen callers for other purposes during those transactions, such as requests for the replacement of a credit card.

### SUMMARY OF INVENTION

A method in accordance with the present invention processes requests for financial-related transactions. A communication is received from a caller, and the communication includes a request for a particular financial card. Information is obtained from the customer for use in processing the request. A first set of criteria related to the information is evaluated to determine if the request involves potential fraud, and based upon the evaluation of the first set of criteria, a second set of criteria related to the information is selectively evaluated to determine if the request involves potential fraud. An indication of the evaluation is output and used to determine whether to issue the requested financial card.

Another method in accordance with the present invention facilitates the reduction of fraud associated with a transaction card account and a request for a particular financial card by a caller. A communication is received from a caller, and the communication includes a request for a particular financial card and information for use in processing the request. First and second sets of criteria related to the information are selectively evaluated to determine if the request involves potential fraud, and an action related to the transaction card account is performed based upon the evaluating step. The action includes using the evaluation to determine whether to issue the requested financial card.

### BRIEF DESCRIPTION OF DRAWINGS

The accompanying drawings, wherein like reference numerals represent like elements, are incorporated in and constitute a part of this specification and, together with the description, explain the advantages and principles of the invention. In the drawings,

FIG. 1 is a diagram of an exemplary system for processing calls;

FIG. 2 is a diagram of exemplary components of a system for executing the present invention; and

FIG. 3 is a flow chart of an exemplary method for evaluating sets of criteria for use in a process to issue replacement financial cards.

### DETAILED DESCRIPTION

Overview: The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

In general, in an exemplary embodiment, an agent receives a communication from a caller, the communication including a request for an item (e.g., good, service, transaction, financial card, financial account), information is obtained from the customer for use in processing the request. A first set of criteria related to the information is evaluated to determine if the request involves potential fraud. Based upon the evaluation of the first set of criteria, a second set of criteria related to the information is selectively evaluated to determine if the request involves potential fraud. An indication of the evaluation is output and used to determine whether to issue the requested item.

The system and method disclosed herein may be used to help minimize any fraud related to other transactions such as, for example, telephone communications, merchant communications, travel communications, cardholder communications, opening a transaction card account, closing a transaction card account, opening a related transaction account, changing demographic information related to the account and changing financial information related to the transaction card account. An “account” or “account number”, as used herein, may include any device, code, number, letter, symbol, digital certificate, smart chip, digital signal, analog signal, biometric or other identifier/indicia suitably configured to allow the consumer to interact or communicate with the system, such as, for example, authorization/access code, personal identification number (PIN), Internet code, other identification code, and/or the like which is optionally located on a rewards card, charge card, credit card, debit card, prepaid card, telephone card, smart card, magnetic stripe card, bar code card, transponder, radio frequency card and/or the like. The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a sixteen-digit format will generally use four spaced sets of numbers, as represented by the number “0000 0000 0000 0000”. The first five to seven digits are reserved for processing purposes and identify the issuing bank, card type and etc. In this example, the last sixteenth digit is used as a sum check for the sixteen-digit number. The intermediary eight-to-ten digits are used to uniquely identify the customer. A merchant account number may be, for example, any number or alpha-numeric characters that identifies a particular merchant for purposes of card acceptance, account reconciliation, reporting, or the like.

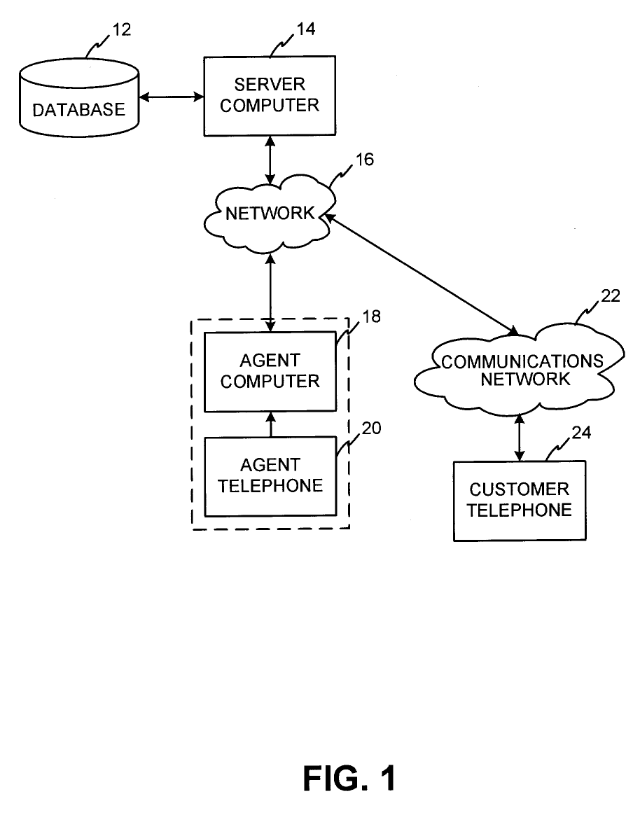

Network Environment: An exemplary system 10 for processing calls is shown in FIG. 1. System 10 includes, in one embodiment, an agent computer 18 having a connection via a network 16 with a server computer 14. Agent computer 18 also includes an associated agent telephone or other oral communication device 20. System 10 includes a customer telephone or other oral communication device 24 for a customer or other type of customer to contact an agent at agent telephone 20 via a communications network 22. While the system will be described herein with respect to telephone communications, one skilled in the art will appreciate that any communication device now known or hereinafter developed may also be used in the present invention. Moreover, while the system and method of the present invention may apply to oral communications, one skilled in the art will appreciate that the present invention may be implemented with other types of communications (e.g., text, graphic, video, etc).

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

The system may include a host server or other computing systems (e.g., at server computer 14, agent computer 18 or customer 24) including a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor and a plurality of databases, said databases including client data, merchant data, financial institution data and/or like data that could be used in association with the present invention. As those skilled in the art will appreciate, customer computer will typically include an operating system (e.g., Windows NT, 95/98/2000, Linux, Solaris, etc.) as well as various conventional support software and drivers typically associated with computers. Customer computer can be in a home or business environment with access to a network. In an exemplary embodiment, access is through the Internet through a commercially-available web-browser software package.

Communication between the parties to the transaction (e.g., network 22) and the system (e.g., network 16) of the present invention may be accomplished through any suitable communication means, such as, for example, a telephone network, Intranet, Internet, point of interaction device (point of sale device, personal digital assistant, cellular phone, kiosk, etc.), online communications, off-line communications, wireless communications, transponder communications and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

In use, in one embodiment, a customer at customer telephone 24 places a telephone call (or other communication) to a particular telephone number which facilitates contacting agent telephone 20. For example, the number(s) could include a customer service help line for a particular entity or institution. Although only one agent computer and telephone are shown, system 10 may include multiple agent computers and telephones, such as in a call center, for receiving calls from customers, and a particular customer's call from customer telephone 24 can be routed to an available agent via a switching device such as a private branch exchange (PBX). Upon reaching an agent, customer telephone 24 is in communication with agent telephone 20 via communications network 22. As discussed above, communication network 22 can include any wireline or wireless network for telephone calls. Network 16 can include any wireline or wireless network for data transmission such as, for example, a Transmission Control Protocol/Internet Protocol (TCP/IP) network.

Agent telephone 20 can receive calls via communications network 22 from a variety of customer telephones. For example, the telephones discussed herein can include a conventional wireline telephone, a wireless or mobile telephone, a speaker phone, an Internet Protocol (IP) telephone, or a personal computer (PC) telephone. In addition, although shown separately in this example, agent telephone 20 and agent computer 18 can be implemented with the same or different physical devices.

As described herein, the computing units may be connected with each other via a data communication network. The network may be a public network and assumed to be insecure and open to eavesdroppers. The network may be embodied as the internet. In this context, the computers may or may not be connected to the internet at all times. For instance, the customer computer may employ a modem to occasionally connect to the internet, whereas the computer may maintain a permanent connection to the internet. Specific information related to the protocols, standards, and application software utilized in connection with the Internet may not be discussed herein. For further information regarding such details, see, for example, Dilip Naik, “Internet Standards and Protocols” (1998); “Java 2 Complete”, various authors, (Sybex 1999); Deborah Ray and Eric Ray, “Mastering HTML 4.0” (1997); Loshin, “TCP/IP Clearly Explained” (1997). All of these texts are hereby incorporated by reference.

The systems may be suitably coupled to the networks via data links. A variety of conventional communications media and protocols may be used for data links. Such as, for example, a connection to an Internet Service Provider (ISP) over the local loop as is typically used in connection with standard modem communication, cable modem, Dish networks, ISDN, Digital Subscriber Line (DSL), or various wireless communication methods. The system might also reside within a local area network (LAN) which interfaces to network via a leased line (T1, D3, etc.). Such communication methods are well known in the art, and are covered in a variety of standard texts. See, e.g., Gilbert Held, “Understanding Data Communications” (1996), hereby incorporated by reference.

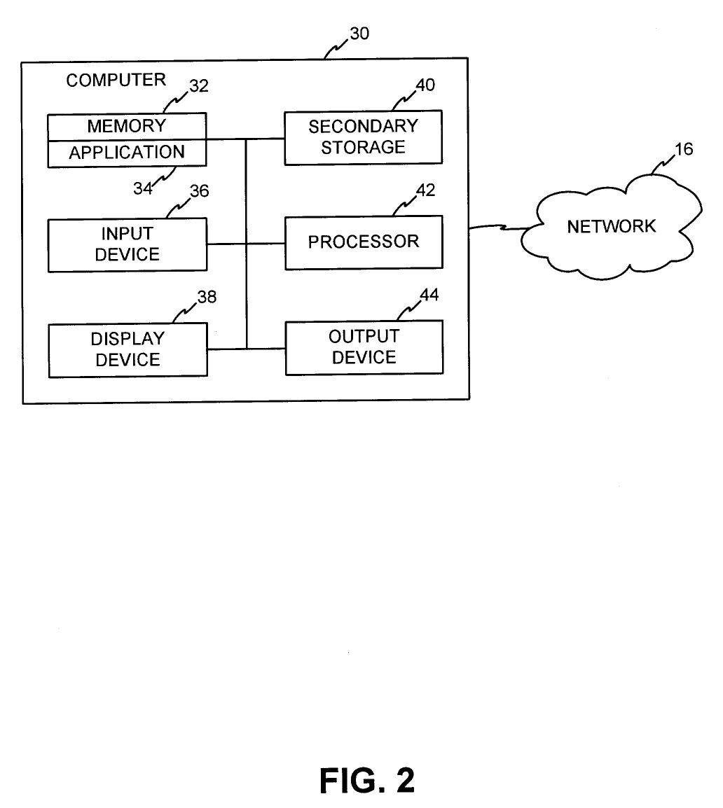

FIG. 2 is a diagram of a exemplary computer 30 illustrating typical components of server computer 14 and agent computer 18. Computer 30 can include a connection with network 16 such as the Internet through any suitable network connection. Computer 30 typically includes a memory 32, a secondary storage device 40, a processor 42, an input device 36 for entering information into computer 30, a display device 38 for providing a visual display of information, and an output device 44 for outputting information such as in hard copy or audio form. Memory 32 may include random access memory (RAM) or similar types of memory, and it may store one or more applications 34 for execution by processor 42.

Secondary storage device 40 may include a hard disk drive, floppy disk drive, CD-ROM drive, or other types of non-volatile data storage. Processor 42 may execute applications or programs stored in memory 34 or secondary storage 40, or received from the Internet or other network 16. Although computer 30 is depicted with various components, one skilled in the art will appreciate that the server and agent computers can contain different components.

Methodology: The present invention may be described herein in terms of functional block components, optional selections and various processing steps. As discussed above, it should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography,” by Jonathan Knudson, published by O'Reilly & Associates (1998); (3) “Cryptography & Network Security: Principles & Practice,” by William Stalling, published by Prentice Hall; all of which are hereby incorporated by reference.

It will be appreciated, that many applications of the present invention could be formulated. One skilled in the art will appreciate that the network may include any system for exchanging data or transacting business, such as the Internet, an intranet, an extranet, WAN, LAN, satellite communications, and/or the like. It is noted that the network may be implemented as other types of networks, such as an interactive television (ITV) network.

The customers may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, Solaris or the like. Moreover, although the invention is frequently described herein as being implemented with TCP/IP communications protocols, it will be readily understood that the invention could also be implemented using IPX, Appletalk, IP-6, NetBIOS, OSI or any number of existing or future protocols.

Any databases discussed herein may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access or MSSQL by Microsoft Corporation (Redmond, Wash.), or any other database product. Database may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

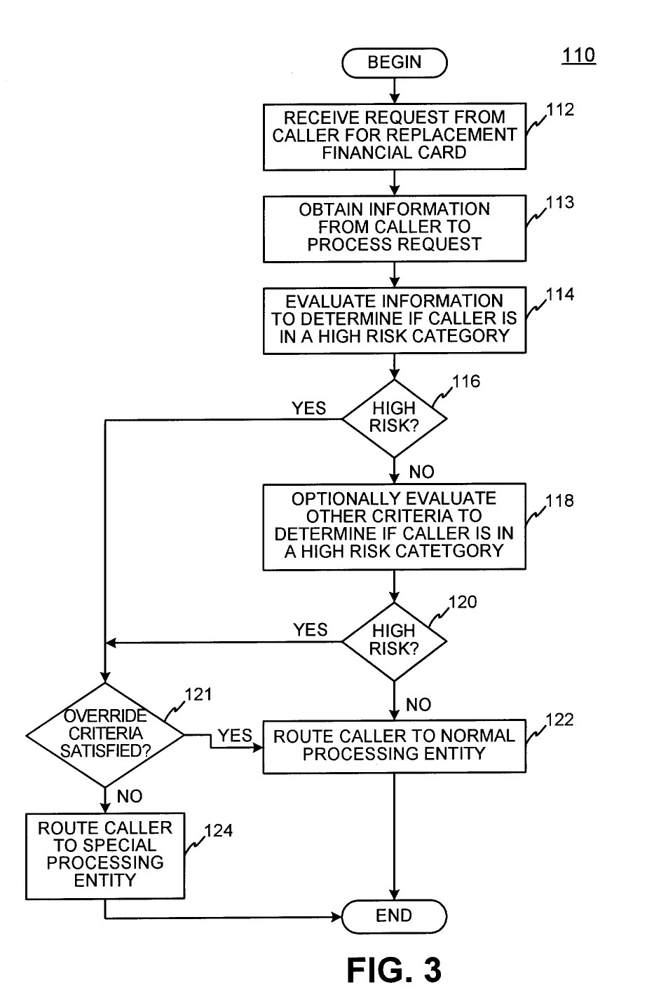

FIG. 3 is a flow chart of an exemplary method 110 for evaluating sets of criteria for use in a process to respond to requests for items such as, for example, issuing replacement financial cards. As discussed above, method 110 can be implemented in, for example, software modules for execution by server computer 14. In exemplary method 110, server computer 14 receives a request from the customer for a replacement financial card (step 112), typically occurring during the processing of calls. The system obtains information from the customer in order to process the request (step 113). The system evaluates a first set of criteria related to the information to determine if the customer is in a high risk category (step 114).

In one embodiment, a customer service representative requests certain information from the customer and enters the information into the system. In another embodiment, the customer may enter information into a web form or send an e-mail with certain information. In this regard, the computers discussed herein may provide a suitable website, webpage or other Internet-based graphical customer interface which is accessible by users. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access or SQL Server, Oracle, Sybase, Informix MySQL, Intervase, etc., may be used to provide an ADO-compliant database management system. The term “webpage” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like. A server may include a webservice which receives a request from a browser which includes a URL (http://yahoo.com/stockquotes/ge) and an IP address (123.56.789). The webservice retrieves the appropriate webpages and sends the webpages to the IP address.

This evaluation can be based upon any set of criteria or factors. For example, the set of criteria can include a satisfactory ANI and/or password by the customer. In one embodiment, if the ANI for the customer does not match any of the entries on a pre-approved list of ANI numbers, or if the password provided does not match the password stored for the customer, the system can determine that the customer is in a high risk category. If the system determines that the customer is in a high risk category (step 116), it can route the customer to a special processing entity to provide further analysis as to whether this request for a replacement card potentially involves attempted fraud (step 124).

Server 14 can also optionally evaluate a second set of criteria to determine or confirm if the customer is in a high risk category (step 118). Second criteria can include any factors or information relating to a particular customer. The evaluations of the first and second sets of criteria can involve, for example, table-driven logic to compare the information from step 113 with information previously obtained and stored for the customer. The system can also obtain data related to the criteria from other databases through various networks in real-time or on a periodic basis.

If the system determines that the customer is in a high risk category, as determined by the other criteria (step 120), it can in addition evaluate override criteria (step 121), explained below, to determine whether the customer can be routed to normal processing despite having satisfied a criteria for a high risk category as determined in step 118. If the customer satisfies an override criteria (step 121), the customer can be routed to the normal processing entity (step 122). As discussed herein, the system may route the customer automatically or provide an indicator to a customer service representative with routing instructions.

Otherwise, if the customer did not satisfy an override criteria (step 121), the customer can be routed to the special processing entity to provide further analysis as to whether this request for a replacement card potentially involves attempted fraud (step 124). The special processing entity can include, for example, the Card Replacement Unit Special Handling (CRUSH) used by American Express® in which specialized procedures, including advanced identification requirements, are handled by staff trained to detect attempted fraud.

The further analysis can include analysis of additional personal information of the caller. For example, the customer can be queried to provide other personal information, and the system can determine whether the provided information matches the corresponding information previously provided or acquired from other databases, wherein the information may be stored in association with a customer identifier.

Otherwise, if the customer is not within one of the high risk categories or satisfies an override criteria, the system can route the customer to the normal processing entity to complete the process of issuing a replacement financial card (step 122).The normal processing entity can include, for example, the Card Replacement Unit (CRU) used by American Express® to provide lower cost and handling time for transactions not deemed to be in a high risk category. Such processing may include, for example, the customer entering a social security number or other variable and having that information, along with the customer's other information, routed to a representative to provide for issuance and mailing of the card to the customer and de-activation of the card that is being replaced.

The evaluation of override criteria to override what would otherwise constitute a high risk transaction may include the following exemplary criteria. The system can determine whether it detects an ANI match, meaning that the customer is calling from a phone number matching a number used in the past. The system can also determine whether the caller's phone number matches a phone number previously recorded for the caller. Moreover, the system can determine whether the customer has entered a valid password previously associated or recorded with the caller. In this regard, the system may override the normal process and not route the customer to the special processing entity if the customer if one or more of the override criteria are met. Other override criteria may also exist depending upon a particular implementation. While the present invention has been described in connection with an exemplary embodiment, it will be understood that many modifications will be readily apparent to those skilled in the art, and this application is intended to cover any adaptations or variations thereof. For example, various types of customer phones, communications networks, and hardware and software implementations of the processing may be used without departing from the scope of the invention. This invention should be limited only by the claims and equivalents thereof.

1. A method for facilitating the processing of requests for an item, comprising:
receiving a communication from a caller, the communication including a request for said item;
obtaining information from the customer for use in processing the request;
evaluating a first set of criteria related to the information to determine if the request involves potential fraud;
selectively evaluating, based upon the evaluation of the first set of criteria, a second set of criteria related to the information to determine if the request involves potential fraud; and
outputting an indication of the evaluating step and using the indication to determine whether to issue the requested item.

2. The method of claim 1, wherein said step of receiving a communication from a customer includes receiving a communication from a customer wherein said item is at least one of a good, service, transaction, financial account and financial card.

3. The method of claim 1 wherein the evaluating the first set of criteria step includes at least one of evaluating information from an automatic number identification service and information from a password provided by the caller.

4. The method of claim 1, further including evaluating override criteria related to the customer for use in determining whether to issue the requested item.

5. The method of claim 1, further including using the outputted indication to determine whether to authorize a transaction requested by the caller.

6. An apparatus for facilitating the processing of requests for financial-related transactions, comprising:
a module configured to receive, via a communications network, a communication from a caller, the communication including a request for a particular financial card;
a module configured to obtain information from the customer for use in processing the request;
a module configured to evaluate a first set of criteria related to the information to determine if the request involves potential fraud;
a module configured to selectively evaluate, based upon the evaluation of the first set of criteria, a second set of criteria related to the information to determine if the request involves potential fraud; and
a module configured to output, via a network, an indication of the evaluating and using the indication to determine whether to issue the requested financial card.

7. A method for facilitating the reduction of fraud associated with a transaction card account and a request for a particular financial card by a caller, said method comprising:
receiving a communication from a caller, the communication including a request for a financial card and information for use in processing the request;
selectively evaluating first and second sets of criteria related to the information to determine if the request involves potential fraud; and,
performing an action related to the transaction card account based upon the evaluating step, including using the evaluating to determine whether to issue the requested financial card.

8. The method of claim 7 wherein the selectively evaluating step includes evaluating information for an automatic number identification service and information for a password provided by the caller.

9. The method of claim 7, further including using the outputted indication to determine whether to authorize a transaction requested by the caller.

10. The method of claim 7, wherein said step of performing an action includes at least one of opening a transaction card account, closing a transaction card account, opening a related transaction account, changing demographic information related to said account and changing financial information related to said transaction card account.

11. The method of claim 7, further including evaluating override criteria related to the customer for use in determining whether to perform the action related to the transaction card account.
